(19) United States
(12) Patent Application Publication
(10) Pub. No.: US 2002/0038954 A1
(43) Pub. Date: Apr. 4, 2002

(54) Protected welded joint for fluid transport pipes and its manufacturing process

(76) Inventor: Juan Domingo Andreoli, Pcia. Buenos Aires (AR)

Correspondence Address: BIRCH STEWART KOLASCH & BIRCH, PO BOX 747, FALLS CHURCH, VA, 22040-0747, US

(21) Appl. No.: 09/943,224

(22) Filed: Aug. 31, 2001

(30) Foreign Application Priority Data
Aug. 31, 2000 (AR) P 00 01 04530

(51) Int. Cl. F16L 13/02

(52) U.S. Cl. 285/288.1; 285/45; 285/397

(57) ABSTRACT

A protected welded joint for fluid transport pipes which will be implemented at the ends of each pipe segment to be welded together, the pipes being of the type having a protective layer inside, and where the welded joint area has inside it an annular sleeve. The joint is composed of this sleeve which is laminar and tubular, and made of stainless steel, and has both ends curved outward, forming an arched rim whose maximum diameter when adjusted corresponds to the internal diameter of each pipe segment. At the curved ends of each sleeve there are individual annular containment seals. The opposite ends of each segment prepared to be welded are separated from one another, leaving a certain space, and each of them has, at a short distance from the respective end, individual radial drill holes. These holes pass through the wall of the corresponding tubular element at each of its ends, and are plugged with threaded stoppers. The drill holes are arranged on diametrically opposed generating lines on each pipe and the free space between the pipe wall and the sleeve is occupied by an epoxy resin compound.

This invention relates generally to methods and resulting approaches for making welded joints which are needed when laying pipes, and relates in particular to a welded and protected joint for fluid transport pipes and a method for producing this joint. The primary object of the invention is to offer a simple design which is applied to form the joint by welding successive segments of pipe together in such a way as to ensure that they remain continuously and hermetically interlinked.

Another object of the invention is that the optimum interlinking of the components which form the hermetic joint guarantee that the entire area thermally affected by the action of the weld is guaranteed, thus perfectly protecting it from the corrosive and abrasive action of the transported product.

Another object of the invention is that, due to the economical design and the simplicity of the method required to produce it, the costs of installation and of distribution are considerably reduced, maintenance is not necessary, and possible losses of the fluid being transported with resulting shutdown of the pipeline due to problems which have originated in any of the welded areas of the pipeline are thus avoided.

This invention has other advantages, in that this is an entirely simple new design with special application for transport of fluids such as water, avoiding oxidation of the joints, with even more particular application for crude oil, whose known corrosive and abrasive actions due to the acid elements or the solids which it entrains, and which are characteristic of this substance, have been prevented by the simple design and the method for obtaining it by the invention.

1. Prior Art

There are a number of different approaches in the prior art. Among the most familiar are ones which have been patented by this applicant firm. These are: U.S. Pat. No. 247,283 referring to a “Coupling for pipes of the sleeve type”, which describes a design composed of three parts which form the joint by a pin and sleeve, including an O-ring. This approach describes a continuous joint without change in its internal diameter, in which the welded area formed in one of the auxiliary parts is thereby separated from the inside of the pipeline and outside the reach of the transported fluid. It is a good approach but very costly to produce.

Another design of equivalent operating efficiency was described in U.S. Pat. No. 248,448, “Joint for pipe segments” which disclosed another design similar to the one above, wherein the complementary parts which are connected to allow joining in the field are welded in the factory where an internally threaded flange is added. In the field, the joint is completed by simply screwing them together and inserting an O-ring between them.

There is yet another patent, U.S. Pat. No. 241,053, wherein one of the pipe segments has at one of its ends a projection in the shape of a truncated cone and a joining nut. The end of the other pipe has a flat face and is externally threaded. Between both ends an elastomer piece is inserted, which is in the shape of a truncated cone on each opposite surface, and which is locked on one side to the projection and in the shape of a truncated cone and on the other hand abuts the flat surface of the threaded pipe.

There is also U.S. Pat. No. 249,604 describing an “assembly of coupled pipes”, with priority of the U.S. Pat. No. 5,346,261 which describes an “assembly of coupled pipes which have a lower conical sleeve”, granted without description, based in turn on a continuation of U.S. Pat. No. 4,913,465 which already anticipated the basic characteristics of the internal sleeve. This patent states, among others, that this sleeve is mounted by using a pair of O-rings, inside the end zones of the two segments of pipe to be welded to form a joint. The sleeve has, in the central area which is corresponding to the weld, a thinner region within which a layer of heat-resistant material, silicon-based or of the asbestos type, can be placed. The fitting has three “retaining elements”, one of which projects outwards, arranged radially 120° apart, to retain the insulating layer of asbestos. This design, in addition to its complexity which makes it difficult to install properly inside the pipes to be welded, has the critical disadvantage that because the pipes are not perfectly cylindrical, the inserted O-rings do not manage to completely stop the high pressure crude oil from quickly seeping into the joint area, thus reaching the sleeve attachment elements and destroying them. This causes the “drift” of the sleeves along the pipe, leaving the welded joint exposed, which will itself then be corroded by the fluid, causing losses in the pipeline.

U.S. Pat. Nos. 5,547,228 and 5,566,984 consist in a “cylindrical barrier to corrosion for pipeline connections”, contingent on one another and also on the aforementioned U.S. Pat. Nos. 4,913,465 and 5,346,261 . They present certain improvements over the preceding designs: there are more O-rings inserted between the sleeve and the area to be welded; they have so-called “spacers”; in the sleeve construction material, which is claimed as non-metallic, composed in particular of PFTE; and also in the addition of pins for positioning the sleeve, said pins being removable once the welding is completed. The pins look like those identified previously as projecting, but are now removable. These improvements obviously managed to solve the serious problem caused by seepage through the O-ring seals and to avoid subsequent “drift”of the sleeves along the pipe.

The pipes used in these fluid distribution systems, such as in particular of crude oil, incorporate an internal layer made of an anti-corrosion coating. When the ends of each segment are welded during construction of the transport pipeline, the heat needed to achieve the weld inevitably affects the coating in this area along a length of at least 12.7 mm ½″) of each pipe. This necessitates protection of these affected areas, a problem which still has not been definitively solved with the improvements cited above, since they are all temporary and their advantage lies only in the greater service life which they manage to offer. To solve the problem described above, the applicant has conceived a design and an extremely simple method for easy application, in this particular case for pipelines belonging to crude oil piping facilities, which solves all these problems.

With these objects, the design and joining method which constitute the invention are to be implemented at the ends of each pipe segment to be welded. The pipes are of the type with a protective layer inside. The joint is comprised of a tubular laminar sleeve made of stainless steel (laminar) with both ends curved outward, forming an arched rim whose maximum diameter when adjusted corresponds to the internal diameter of each pipe segment. The opposite ends of each segment prepared to be welded are separated from one another, leaving a certain space, and each of them has at a short distance from the respective end a radial drill hole plugged with a threaded stopper, which passes through the wall of the corresponding tubular element at each of its ends, the drill holes of which are arranged on diametrically opposed generating lines on each pipe. The installed assembly of a pair of adjacent pipes bearing the sleeve includes at both ends U-shaped individual containment seals, leaving a free space between the pipe wall and the sleeve, in which an epoxy compound is injected through the threaded orifice located at the lower level, without the stopper in, until the compound flows through the top, filling the said remaining space, after which time the hole is plugged with the stopper.

To better explain this invention, which consists in a welded and protected joint for pipes and a method for obtaining it and which has special application for oil pipelines, a precise description will be given below of the preferred embodiment of the invention, in order to demonstrate its use in such a way that the joint can easily be implemented with reference to the accompanying illustrative diagrams. This is done purely to provide a non-restrictive example of the invention, the components of which could be selected from among various equivalents without actually departing from the protective scope of the invention as described in this document.

### DIAGRAMS

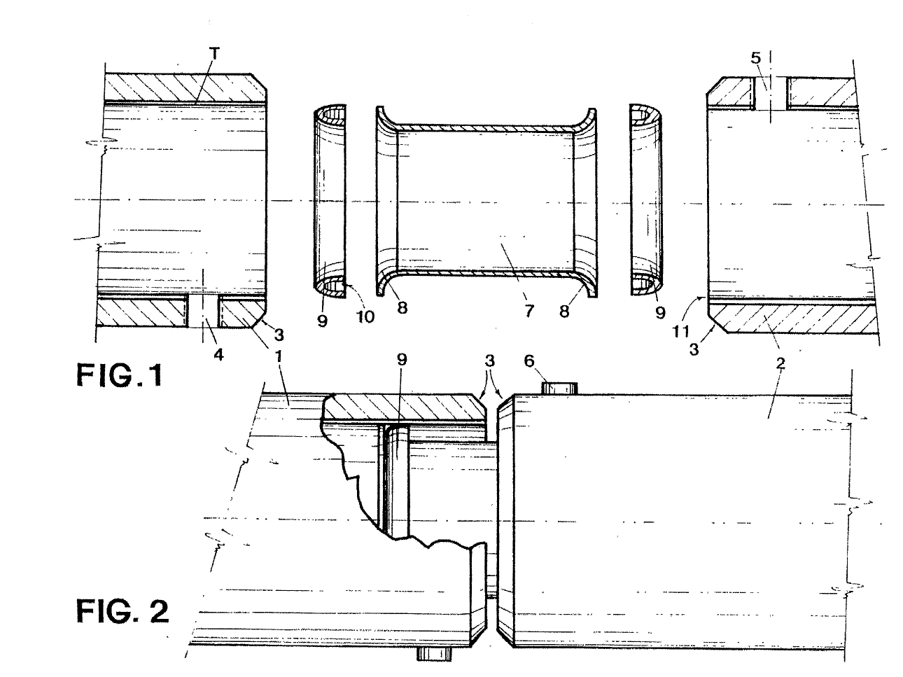

FIG. 1 shows an exploded partial schematic view of the design according to the invention, drawn in longitudinal cross-section.

FIG. 2 shows a partial longitudinal view of the joint design, with one part illustrated in cross-section, demonstrating how the component parts are joined to one another to form the weld.

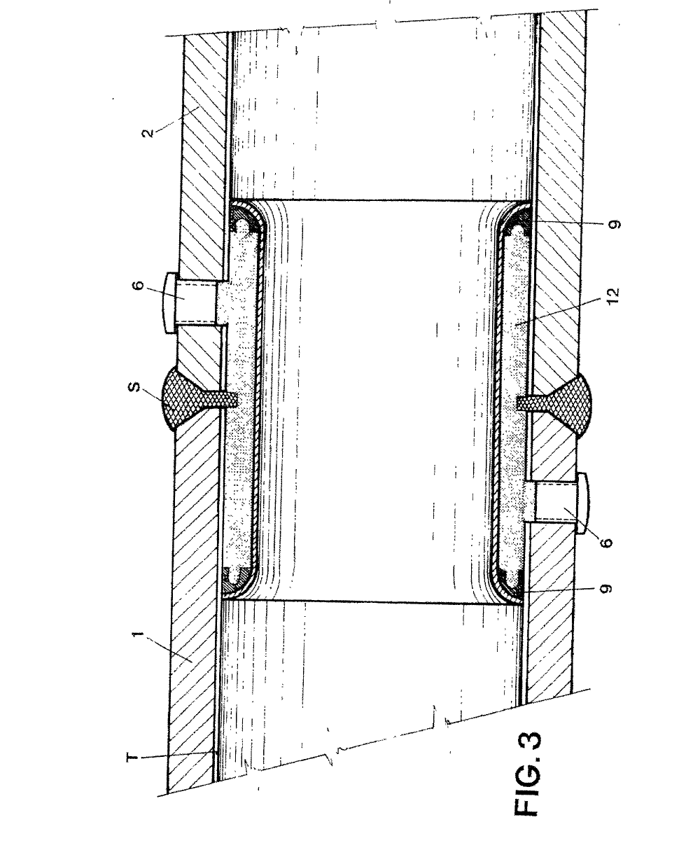

FIG. 3 is a partial view in longitudinal cross-section of the finished welded and protected joint.

In the figures above, the same reference numbers indicate the same or corresponding parts.

### DESCRIPTION

As per the diagrams in the figures, the ends belonging to pipe segments -1- and -2- to be welded have their edges -3- curved to accommodate the welding deposit in the conventional manner and their orifices -4- and -5- are threaded and located on diametrically opposite sides with respect to the welded joint of each pipe, said orifices being equipped with threaded stoppers or threaded caps labeled as -6-.

The internal sleeve is comprised of a laminar body resistant to the welding temperature and composed of an anti-corrosion material, for example stainless steel. The body is of cylindrical shape -7-, having opposite ends -8- arched and curved outwards in such a way that the diameter of its edges fits the internal diameter of each pipe -1- and -2-.

The necessary parts are completed with a pair of annular containment seals -9- with U-shaped cross-section -10-. Seals of the “U-packing” type can be used.

The ends -11- of both pipes are butted for welding, leaving a space of roughly 3 mm for the conventional diameter used in the oil pipelines, which will be occupied by the weld. The weld seam will run internally to a certain extent, forming an annular edge which takes the longitudinal load, preventing movement of the sleeve. To form weld -S-, the stoppers -6- are removed to allow escape of the heated air and to avoid destruction of the seals -9-. Once the weld is completed, compressed air is used to clean it and an epoxy resin -12- is injected under pressure to fill the annular space confined between the walls of the pipes -1- and -2-, the sleeve -7- and the containment seals -9- which abut the curved ends -8- of the sleeve. The operation is finished by screwing the stoppers or threaded caps -6- into position.

### OPERATION

Now that the different components of this embodiment of the invention have been detailed to explain their nature, a description of the functional and operating relationship of their parts and the results thereof shall be detailed below.

The operating relationship is very simple and is based on the description already given in the preceding sections.

As with any welded joint, prior preparation in the workshop or in the factory is required, which involves beveling the tips on each segment of pipe -1- and -2-, and in the case of the invention also the drilling and threading of holes -4- and -5- proximate to the ends of each pipe and subsequent plugging of these holes with stoppers -6-, forming and machining of the sleeve -7-, and procuring the seals -9-.

At the installation site, the procedure is to take the sleeve -7- in the middle area using a special tool and insert it halfway into one of the pipes -1- -2- while it is bearing one of the seals -9-, then fitting the other seal -9- into place. The second pipe is then positioned in such a way that preferably the axes of holes -4- and -5- remain in a vertical position, and the pipe is inserted subsequently onto the sleeve bringing its end to within a few millimeters from the end of the other pipe. Once this is done, welding can be carried out around the entire joint using the conventional method. Once welding is completed, epoxy resin is injected under pressure into the hole which is located in the lowest level, until it flows through the opposite hole.

Subsequently, stoppers -6- are inserted to prevent loss of resin.

The method involves the following steps: preparation of the pipe segments with the anti-corrosion coating, drilling and threading the holes and their accessories; placing the protective sleeve at one end of the pipe segment-up to half its length, with its two seals; insertion of the second pipe segment onto the projecting body of the sleeve; bringing the two ends closer together, to within roughly 3 mm; forming the weld which shapes the joint; injection of an epoxy resin up to the drill hole located at a lower level until it flows through the top one; and plugging of the holes using their threaded stoppers.

This has been a description of one of the embodiments of the invention and a method of implementing it, and the manner in which this embodiment operates, including in addition its preferred specific application. This document also includes a summary of the invention, contained in the claims attached hereto.

Having described and established the composition of the invention, its scope and the manner in which it can be implemented in terms of its basic concept, the following claims declare this invention to be exclusive intellectual property:

1. Protected welded joint for fluid transport pipes which will be implemented at the ends of each pipe segment to be welded together, said pipes being of the type having a protective layer inside, and where the welded joint area has inside it an annular sleeve, characterized in that: the joint is composed of this sleeve which is laminar and tubular, and made of stainless steel, and has both ends curved outward, forming an arched rim whose maximum diameter when adjusted corresponds to the internal diameter of each pipe segment; at the curved ends of each sleeve there are individual annular containment seals; the opposite ends of each segment prepared to be welded are separated from one another, leaving a certain space, and each of them has at a short distance from the respective end individual radial drill holes, which holes pass through the wall of the corresponding tubular element at each of its ends, and are plugged with threaded stoppers; the drill holes are arranged on diametrically opposed generating lines on each pipe; and the free space between the pipe wall and the sleeve is occupied by an epoxy resin compound.

2. Protected welded joint for fluid transport pipes, as claimed in claim 1, wherein this sleeve is cylindrical and is formed with an anticorrosion material resistant to the welding temperature.

3. Protected welded joint for fluid transport pipes as claimed in claims 1 or 2, wherein this seal has a transverse U-shaped cross-section.

4. Method for producing the protected welded joint for fluid transport pipes, as claimed in claims 1, 2 and 3, which comprises preparation of the ends of each pipe segment (of the type having an anticorrosion layer), curving them so as to receive the weld, wherein it is comprised of the following steps: drilling and threading the holes located on opposite generating lines of each segment; insertion of the protector sleeve in one of the ends of the first pipe to half its length, with its two seals; insertion of the second pipe segment onto the projecting body portion of the sleeve, bringing the two ends to within roughly 3 mm of one another; performing the peripheral annular welding which shapes the joint; injection of an epoxy resin up to the drill hole located at a lower level until it flows through the top one; and plugging of the holes using their threaded stoppers.

5. Method for producing the protected welded joint for fluid transport pipes, as claimed in claims 1, 2, 3 and 4, wherein prior to the step in which the epoxy resin is injected, these pipe segments are arranged in such a way that the axes of the drill holes made at their opposite ends are preferably in a vertical plane.
